(19) United States
(12) Patent Application Publication
(10) Pub. No.: US 2005/0201394 A1
(43) Pub. Date: Sep. 15, 2005

(54) Storage gateway and data backup method therefor

(75) Inventors: Jain-Chung Wang, Tu-Cheng (TW); Yu-Jen Lin, Tu-Cheng (TW); Chen-Yu Chen, Tu-Cheng (TW); Chih-Yuan Huang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/072,811

(22) Filed: Mar. 4, 2005

(30) Foreign Application Priority Data
Mar. 13, 2004 (CN) 200410026506.6

(51) Int. Cl. H04L 12/66

(52) U.S. Cl. 370/401

(57) ABSTRACT

A storage gateway (2) includes: a media card reader (23) for reading data from an external media card (25); a storage device (20) for storing the data read from the media card; a data folder (200) for storing a plurality of subfolders (2000), the subfolders being for storing card IDs (250) of various media cards and the data of the media card; and at least two LEDs (22, 28) for denoting different states of the storage gateway. A related data backup method comprises: checking whether there is a card ID in the media card; checking whether there is a subfolder in a data folder if there is a card ID in the media card; determining whether the entire data of the media card are in the subfolder, if there is a subfolder in the data folder; copying the data; and examining whether the copying is completed.

### BACKGROUND OF THE INVENTION

1. Field of the Invention

The present invention relates to computer and communication network devices, and particularly to a storage gateway and a data backup method for the storage gateway.

2. Prior Art

With the ongoing development of the Internet, how to store data effectively and efficiently is becoming even more important than before. Different storage devices have individual hardware and software infrastructures for storing data. A gateway may have an internal storage device or an external storage device for storing data.

FIG. 4 is a block diagram of a conventional storage gateway 10. A media device 12 and an external storage device 13 are connected to the storage gateway 10 via USB interfaces 11. A plurality of personal computers 15 is connected to the storage gateway 10 respectively via Local Area Network (LAN) interfaces 14 or fiber/wireless interfaces 16. Users can transmit instructions to copy information through the personal computers 15, when the media device 12 and the personal computers 15 are powered on. The storage gateway 10 duly backs up the data of the media device 12, with the data being stored in an internal storage device 100 of the storage gateway 10 or in the external storage device 13. After the data are backed up, the connection between the media device 12 and the storage gateway 10 is turned off. One shortcoming of the storage gateway 10 is that it is necessary to start up the personal computers 15 each time copying of the data from the media device 12. This makes the procedure unduly complicated. For further reference, an example of a product using conventional storage technology is the USR8200 firewall/VPN produced by USRobotics®.

### SUMMARY OF THE INVENTION

A first objective of the present invention is to provide a storage gateway having an integrated media card reader for backing up data from an external media card to the storage gateway.

A second objective of the present invention is to provide a data backup method which utilizes the above-described storage gateway.

In order to accomplish the above-mentioned first objective, a preferred embodiment of a storage gateway comprises: a media card reader for reading data from an external media card; a storage device for storing the data read from the media card; a data folder for storing a plurality of subfolders, the subfolders being for storing card IDs of various media cards and the data of the media card; and at least two Light Emitting Diodes (LEDs) for denoting different states of the storage gateway.

In order to accomplish the above-mentioned second objective, a data backup method of the present invention comprises the steps of: (i) setting the storage gateway as backup enabled; (ii) checking whether there is a card ID in the media card; (iii) checking whether there is a subfolder in a data folder of the storage gateway which corresponds to the media card, if there is a card ID in the media card; (iv) determining whether the entire data of the media card are in the subfolder, if there is a subfolder in a data folder of the storage gateway which corresponds to the media card; (v) copying the data of the media card to the subfolder, if the entire data of the media card are not in the subfolder; and (vi) determining whether the copying is completed.

Other objects, advantages and novel features of the present invention will be drawn from the following detailed description with reference to the attached drawings, in which:

### BRIEF DESCRIPTION OF THE DRAWINGS

FIG. 1 is a schematic diagram of an application environment of a storage gateway in accordance with the preferred embodiment of the present invention;

FIG. 2 illustrate display states of LEDs of the storage gateway of FIG. 1;

FIG. 3 is a flow chart of a preferred data backup method in accordance the present invention; and

FIG. 4 is a block diagram of an application environment of a conventional storage gateway.

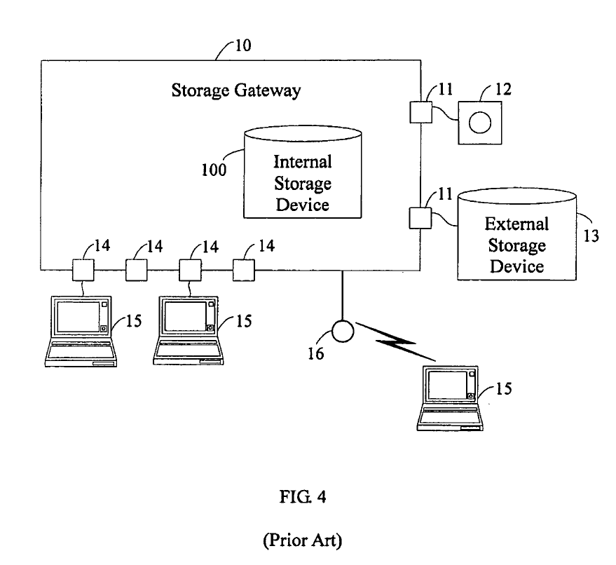

### DETAILED DESCRIPTION OF THE INVENTION

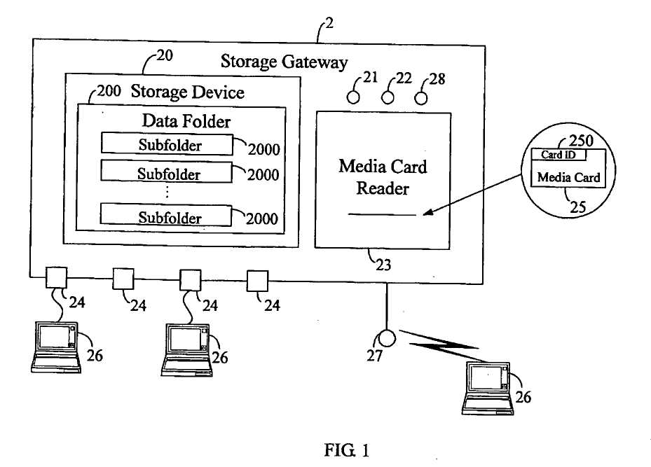

FIG. 1 is a schematic diagram of an application environment of a storage gateway 2 in accordance with the preferred embodiment of the present invention. In the preferred embodiment, the storage gateway 2 comprises a storage device 20, a card reader activity Light Emitting Diode (LED) 21, a card reader backup LED 22, a power LED 28 and a media data source like a media card reader 23. The media card reader 23 is used for reading data stored in a media card 25. The storage device 20 comprises a data folder 200, which includes a plurality of subfolders 2000. The subfolders 2000 are provided for storing the data read by the media card reader 23. A plurality of personal computers 26 is connected to the storage gateway 2 respectively via LAN interfaces 24 or fiber/wireless interfaces 27. The personal computers 26 are used for setting parameters related to backup states of the storage gateway 2.

In the preferred embodiment, the media card 25 is directly inserted into the media card reader 23 in the storage gateway 2. The media card reader 23 is used for reading data stored in the media card 25, and for storing the data in the storage device 20. A card ID 250 is solely assigned to the media card 25 for identification. The power LED 28 indicates whether the storage gateway 2 is working. The card reader activity LED 21 indicates whether the media card 25 is inserted into the media card reader 23, and the card reader backup LED 22 indicates whether the storage gateway 2 backs up the data stored in the media card 25. The card reader activity LED 21 and the card reader backup LED 22 are provided together for indicating different working states of the media card reader 23 and the storage gateway 2.

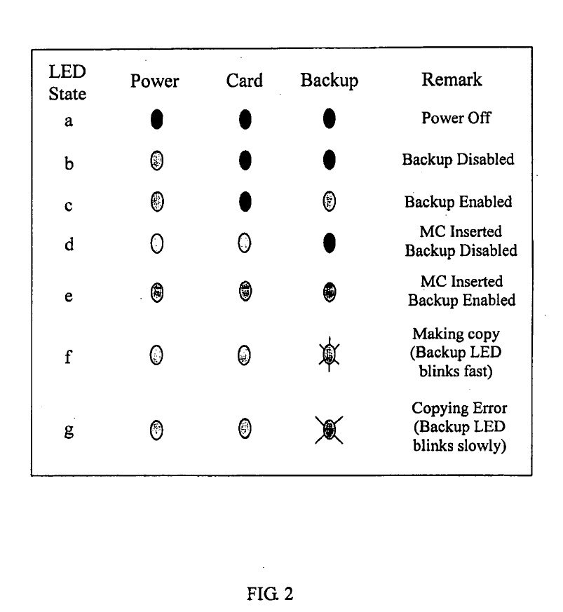

Referring to FIG. 2, three LEDs of the storage gateway 2 are the card reader activity LED 21, the card reader backup LED 22, and the power LED 28. The LEDs 21, 22, 28 collectively presents any of the following seven states in which the storage gateway 2 is: a. the card reader activity LED 21, the card reader backup LED 22 and the power LED 28 are off, when the storage gateway 2 is powered off; b. the power LED 28 lights up, and the card reader activity LED 21 and the card reader backup LED 22 are off, when the storage gateway 2 is set as backup disabled by users through one of the personal computers 26, and the media card 25 is not inserted into the media card reader 23; c. the card reader activity LED 21 is off, and the power LED 28 and the card reader backup LED 22 light up, when the storage gateway 2 is set as backup enabled by users through one of the personal computers 26, and the media card 25 is not inserted into the media card reader 23; d. in the backup disabled state of the storage gateway 2, the card reader backup LED 22 is off, and the power LED 28 and the card reader activity LED 21 light up, when the media card 25 is inserted into the media card reader 23. At the time, the data stored in the media card 25 is not backed up to the storage gateway 2; e. in the backup enabled state of the storage gateway 2, the power LED 28, the card reader activity LED 21 and card reader backup LED 22 light up, when the media card 25 is inserted into the media card reader 23. At the time, the data stored in the media card 25 is automatically backed up to the storage gateway 2; f. the power LED 28 and the card reader activity LED 21 light up, and the card reader backup LED 22 blinks fast, while the storage gateway 2 is copying the data of the media card 25; and g. the power LED 28 and the card reader activity LED 21 light up, and the card reader backup LED 22 blinks slowly, if an error has occurred during the copying process.

As seen, in the preferred embodiment, the card reader backup LED 22 indicates two backup states of the storage gateway 2: backup enabled and backup disabled. Parameters related to the two backup states are set by users through one of the personal computers 26. For example, “1” can indicate backup enabled, and “0” can indicate backup disabled.

Once one parameter related to the backup states of the storage gateway 2, such as an backup enabled parameter, has been set, it is not necessary to modify the backup enabled parameter if a subsequent operation is also backing up the data from the media card 25 to the storage gateway 2. That is, the parameters related to the backup states for the storage gateway 2 are inheritable for subsequent operations. If the subsequent operation is only reviewing the data stored in the media card 25 and not backing up it, only then is it necessary to modify the backup enabled parameter to a backup disabled parameter via the personal computers 26.

When the storage gateway 2 is set as backup disabled, the card reader backup LED 22 is off. At the time, users may review the data of the media card 25 via the personal computers 26 when the media card 25 is inserted into the media card reader 23. When the storage gateway 2 is set as backup enabled, the card reader backup LED 22 lights up. At the time, the media card reader 23 is reading data stored in the media card 25, and storing the data in the storage device 20 when the media card 25 is inserted into the media card reader 23.

The media card 25 comprises a card ID 250 that is solely assigned by a file system in the storage gateway 2. When the media card 25 is substantially inserted into the media card reader 23, the file system in the storage gateway 2 automatically determines whether the media card 25 has a unique card ID 250. If not, the storage gateway 2 generates and assigns a new, unique card ID 250 to the media card 25.

If and when the media card 25 has the unique card ID 250, the file system checks whether there is a subfolder 2000 in the data folder 200 corresponding to the card ID 250. If not, the storage gateway 2 generates a new subfolder 2000 in the data folder 200 corresponding to the card ID 250, and backs up the data of the media card 25 in the newly generated subfolder 2000.

If the subfolder 2000 corresponding to the card ID 250 is in the data folder 200, the file system compares the data of the subfolder 2000 with that of the media card 25. If the data are entirely the same, the file system does not back up the data of the media card 25. Otherwise, the file system backs up the data of the media card 25 to the subfolder 2000.

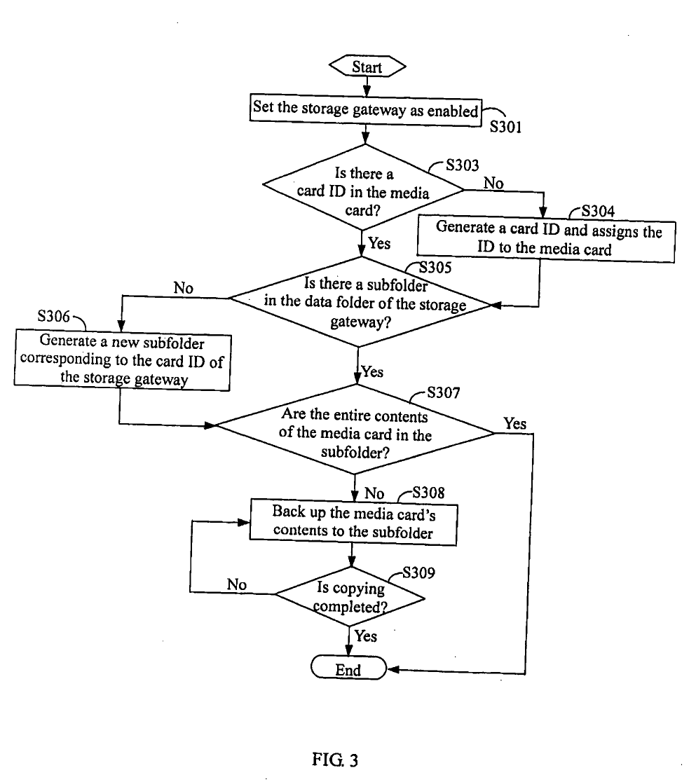

FIG. 3 is a flow chart of the preferred data backup method of the present invention. First of all, the storage gateway 2 is powered on. At step S301, the storage gateway 2 is set as backup enabled.

At step S303, the file system of the storage gateway 2 checks whether there is a card ID 250 in the media card 25. That is, the file system checks whether the media card 25 has been read by the storage gateway 2. If there is no card ID 250 in the media card 25, at step S304, the storage gateway 2 generates a new card ID 250, and assigns it to the media card 25.

If and when the card ID 250 is in the media card 25, at step S305, the file system checks whether there is a subfolder 2000 corresponding to the card ID 250 in the data folder 200 of the storage gateway 2. If there is no corresponding subfolder 2000 in the data folder 200, at step S306, the storage gateway 2 generates a new subfolder 2000 corresponding to the card ID 250 of the storage gateway 2.

If and when the corresponding subfolder 2000 is in the data folder 200, at step S307, the file system determines whether the entire data of the media card 25 are in the subfolder 2000. If the entire data are in the subfolder 2000, the whole backup process is finished. If the entire data are not in the subfolder 2000, at step S308, the storage gateway 2 backs up the data of the media card 25 to the subfolder 2000.

At step S309, the file system determines whether the copying procedure is completed; that is, whether the data of the media card 25 are the same as those of the subfolder 2000. If the data of the media card 25 and those of the subfolder 2000 are different, the procedure returns to step S308, and the ongoing backup process is continued. If and when the data of the media card 25 are the same as those of the subfolder 2000, the whole backup process is finished.

Although only a preferred embodiment and method of the present invention have been described in detail above, those skilled in the art will readily appreciate that many modifications to the preferred embodiment and method are possible without materially departing from the novel teachings and advantages of the present invention. Accordingly, all such modifications are deemed to be covered by the following claims and allowable equivalents of the claims.

1. A storage gateway comprising:
a media card reader for reading data from an external media card;
a storage device for storing the data read from the external media card;
a card reader activity Light Emitting Diode (LED) for denoting reading states of the media card reader; and
a card reader backup LED for denoting backup states of the storage gateway.

2. The storage gateway as claimed in claim 1, wherein the storage device comprises a plurality of subfolders for storing IDs of various external media cards and the data of the external media card.

3. The storage gateway as claimed in claim 1, further comprising a plurality of Local Area Network (LAN) interfaces for connecting the storage gateway to personal computers.

4. The storage gateway as claimed in claim 1, further comprising a power LED.

5. The storage gateway as claimed in claim 4, wherein the power LED, the card reader activity LED and the card reader backup LED collectively define a first state indicating a backup enabled state of the storage gateway.

6. The storage gateway as claimed in claim 4, wherein the power LED, the card reader activity LED and the card reader backup LED collectively define a second state indicating a process of copying the data from the external media card.

7. The storage gateway as claimed in claim 4, wherein the power LED, the card reader activity LED and the card reader backup LED collectively define a third state indicating that an error has occurred during a process of copying the data from the external media card.

8. A method for backing up data from an external media card to a storage gateway, the method comprising the steps of:
(a) setting the storage gateway as backup enabled;
(b) checking whether there is a card ID in the media card;
(c) checking whether there is a subfolder in a data folder of the storage gateway which corresponds to the media card, if there is a card ID in the media card;
(d) determining whether the entire data of the media card are in the subfolder, if there is a subfolder in the data folder of the storage gateway which corresponds to the media card;
(e) copying the data of the media card to the subfolder, if the entire data of the media card are not in the subfolder; and
(f) determining whether the copying is completed.

9. The method for backing up data from an external media card to a storage gateway as claimed in claim 8, wherein step (b) further comprises the step of generating the new card ID and assigning it to the media card if there is no card ID in the media card.

10. The method for backing up data from an external media card to a storage gateway as claimed in claim 8, wherein step (c) further comprises the step of generating a new subfolder corresponding to the media card in the storage gateway, if there is no subfolder in a data folder of the storage gateway which corresponds to the media card.

11. The method for backing up data from an external media card to a storage gateway as claimed in claim 8, wherein step (d) further comprises the step of finishing the whole backup process, if the entire data of the media card are in the subfolder.

12. The method for backing up data from an external media card to a storage gateway as claimed in claim 8, wherein step (f) further comprises returning to step (e) in order to continue the copying of the data of the media card to the subfolder, if the copying is not completed.

13. The method for backing up data from an external media card to a storage gateway as claimed in claim 8, wherein step (f) further comprises the step of finishing the whole backup process, if the copying is completed.

14. A method to backup data from a media data source to a storage gateway, the method comprising the steps of:
identifying working states of said storage gateway;
identifying working states of said media data source;
allowing user's control to enable/disable a backup function of said storage gateway;
expressing said working states of said storage gateway and said media data source, and an enabling state of said backup function via said storage gateway; and
backuping automatically media data from said media data source to said storage gateway in case that said media data source and said storage gateway work, and said backup function of said storage gateway is enabled.

15. The method as claimed in claim 14, further comprising the step of identifying presence of said media data in said storage gateway before said backuping step.

16. The method as claimed in claim 15, wherein backup of said media data is achieved in one of situations including that no identifiable subfolder corresponding to said media data is created in said storage gateway and that data in said identifiable subfolder corresponding to said media data is different from said media data during said presence-identifying step.

17. The method as claimed in claim 14, wherein said media data source is a media card reader and said working states of said media card reader include a no-card-readable state and a card-readable state in said data-source identifying step.

18. The method as claimed in claim 14, wherein said working states of said storage gateway include a power-off state and a power-on state in said storage-gateway identifying step.

19. The method as claimed in claim 14, wherein a light emitting diode (LED) is used to express respectively said working states of said storage gateway and said media data source and a enabling state of said backup function in said expressing step.
